(19) United States
(12) Patent Application Publication
(10) Pub. No.: US 2017/0034408 A1
(43) Pub. Date: Feb. 2, 2017

(54) FOLLOW FOCUS DEVICE

(71) Applicant: Dong Yang Model Technology Co., Limited, Huizhou (CN)

(72) Inventor: Jinhai ZHANG, Huizhou (CN)

(21) Appl. No.: 15/086,748

(22) Filed: Mar. 31, 2016

(30) Foreign Application Priority Data
Jul. 28, 2015 (CN) 201520556021.1

(51) Int. Cl. H04N 5/225

(52) U.S. Cl. CPC H04N 5/2254; H04N 5/2252

(57) ABSTRACT

The present invention relates to a follow-focus device comprising: a first terminal comprising a first housing, a first control module, a transmitting module electrically connected with the first control module, and a synchronizing wheel rotatably disposed on the first housing and electrically connected with the first control module; and a second terminal comprising a second housing having a chute, a second control module electrically connected with the driving motor 5, a receiving module electrically connected with the second control module and the transmitting module, a driving motor fixed on the second housing and drivingly connected with an adjusting gear, an adjusting gear, and a clamping mechanism slidably disposed in the chute. The position of the clamping mechanism on the second housing can be slidably adjusted according to the scene and different cameras, thus fitness between the second housing and the camera is improved, and the follow-focus adjustment effect is better.

### BACKGROUND OF THE INVENTION

Technical Field

The present invention relates to the technical field of camera control, and specifically to a follow focus device.

Description of Related Art

The existing camera or video camera needs to shoot at a high speed or under a severe environment. Under this situation, the photographer cannot directly perform control and follow focus adjustment to the camera or video camera. A wireless follow focus solves such problem efficiently and is used for remote control of the follow focus adjustment of the camera or video camera in the motion shot of the camera or video camera. The wireless follow focus generally includes a wireless controller and a receiver. A control instruction of the wireless controller is transmitted to the receiver through a wireless signal. The receiver controls a driving motor on the receiver to work after receiving the instruction. The driving motor drives an adjusting gear to perform follow focus adjustment to a follow focus adjusting wheel of the camera or video camera. Since the distances between the follow focus adjusting wheels and fixed poles of various existing cameras or video cameras are inconsistent, the receiver of the existing follow focus cannot match the cameras or video cameras efficiently, and cannot be stabilized on the cameras or video cameras, thereby affecting the follow focus effect and shooting effect.

### BRIEF SUMMARY OF THE INVENTION

Based on the above, for the shortage that the existing wireless follow focus cannot match with various cameras or video cameras, so that the receiver cannot be stably fixed on the cameras or video cameras, it is required to provide a follow focus device with a slidable clamping mechanism. The fitness between the follow focus device and the follow focus adjusting wheel of the camera or video camera is improved, such that the follow focus adjustment and shooting effects are better.

A follow focus device includes a first terminal and a second terminal;

The first terminal includes a first housing, a first control module, a transmitting module and a synchronizing wheel; the first control module is disposed within the first housing; the transmitting module is fixedly disposed on the first housing and electrically connected with the first control module; the synchronizing wheel is rotatably disposed on the first housing and electrically connected with the first control module;

The second terminal includes a second housing, a second control module, a receiving module, a driving motor, an adjusting gear and a clamping mechanism; the second control module is disposed within the second housing; the receiving module is fixedly disposed on the second housing and electrically connected with the second control module; the receiving module is connected with the transmitting module; the second control module is electrically connected with the driving motor; the driving motor is fixedly disposed on the second housing and is connected with the adjusting gear in a driving manner; the second housing has a chute; and the clamping mechanism is slidably disposed in the chute.

In an embodiment, the clamping mechanism includes a first connection portion, a clamping ring and a second connection portion integrally formed; the second connection portion is slidably disposed in the chute; the first connection portion, the clamping ring and the second connection portion are orderly connected; and the first connection portion is connected with the second connection portion through a bolt.

In an embodiment, the bolt has a handheld portion.

In an embodiment, the second housing is provided with a transmission gear and a driven gear; the driving motor is connected with the transmission gear; the transmission gear is engaged with the driven gear; and the adjusting gear is engaged with the driven gear.

In an embodiment, the driving motor is connected with a worm engaged with the transmission gear.

In an embodiment, the driven gear has a first tooth surface and a second tooth surface disposed opposite to each other; and the adjusting gear is engaged with the first tooth surface or the second tooth surface.

In an embodiment, the first housing has a fixture block disposed on the outer circumferential side of the synchronizing wheel; and a blocking mechanism for abutting on the fixture block is disposed on the circumference of the synchronizing wheel.

In an embodiment, the blocking mechanism is a blocking bolt; a screw jointing slot is formed on the circumference of the synchronizing wheel; and the blocking screw is screw-jointed on the screw jointing slot of the synchronizing wheel.

In an embodiment, two blocking mechanisms are disposed on the circumference of the synchronizing wheel.

In an embodiment, the transmitting module comprises a transmitting antenna disposed on the first housing; and the receiving module comprises a receiving antenna disposed on the second housing.

With the above-mentioned follow focus device, the position of the clamping mechanism on the second housing can be slidably adjusted according to the shooting scene and different camera or video camera, such that the fitness between the second housing and the camera or video camera is improved, and the follow focus adjustment effect is better. At the same time, the operation difficulty is reduced.

### BRIEF DESCRIPTION OF THE SEVERAL VIEWS OF THE DRAWINGS

FIG. 1 is a structural schematic diagram of a first terminal of a follow focus device of an embodiment of the present invention;

FIG. 2 is another directional structural schematic diagram of the first terminal of the follow focus device of an embodiment of the present invention;

FIG. 3 is a structural schematic diagram of a second terminal of the follow focus device of an embodiment of the present invention;

FIG. 4 is another directional structural schematic diagram of the second terminal of the follow focus device of an embodiment of the present invention;

FIG. 5 is an internal structural schematic diagram of the second terminal of the follow focus device of an embodiment of the present invention;

FIG. 6 is a logical structural schematic diagram of the follow focus device of an embodiment of the present invention.

### DETAILED DESCRIPTION OF THE INVENTION

For ease of understanding of the present invention, the present invention is fully described below with reference to the related accompanying drawings. A preferred implementation of the present invention is provided in the accompanying drawings. However, the present invention can be realized in many different ways and is not limited to the implementation described herein. On the contrary, these implementations are provided for more thorough and complete understanding of the disclosure of the present invention.

Note that, when an element is referred to “being disposed on” another element, it can be disposed on another element directly or with an intervening element. When an element is referred to “being connected with” another element, it can be connected with another element directly or with an intervening element. The terms “vertical”, “horizontal”, “left”, “right” and the like as used herein are only for explanation but not representing the only implementation.

The technical and scientific terms used herein are the same as the general meaning of those skilled in the art of the present invention. The terms used in the specification of the present invention is only for describing the purpose of the specific implementation but not intended to limit the present invention. The term “and/or” used herein includes any and all combinations of one or more related listed items.

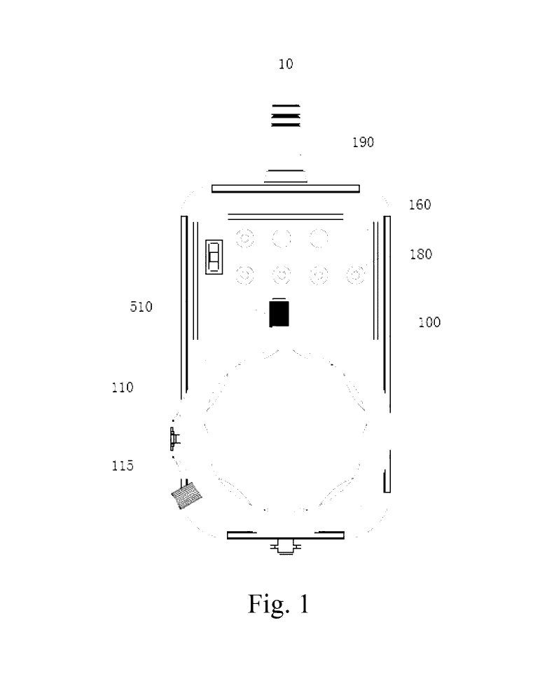

As shown in FIGS. 1, 3 and 6, a follow focus device according to a preferred embodiment of the present invention is provided, including:

A first terminal 10 and a second terminal 20;

The first terminal 10 includes a first housing 100, a first control module 120, a transmitting module 130 and a synchronizing wheel 110; the first control module 120 is disposed within the first housing 100; the transmitting module 130 is fixedly disposed on the first housing 100 and electrically connected with the first control module 120; the synchronizing wheel 110 is rotatably disposed on the first housing 100 and electrically connected with the first control module 120;

The second terminal 20 includes a second housing 200, a second control module 240, a receiving module 250, a driving motor 260, an adjusting gear 210 and a clamping mechanism 220; the second control module 240 is disposed within the second housing 200; the receiving module 250 is fixedly disposed on the second housing 200; the receiving module 250 is electrically connected with the second control module 240 and connected with the transmitting module 130; the second control module 240 is electrically connected with the driving motor 260; the driving motor 260 is fixedly disposed on the second housing 200 and connected with the adjusting gear 210 in a driving manner; the second housing 200 has a chute 230; and the clamping mechanism 220 is slidably disposed in the chute 230.

When in use, the clamping mechanism 220 is clamped on a fixed pole of the camera or video camera for slidably adjusting the position of the clamping mechanism 220 on the second housing 200, such that the adjusting gear can be completely engaged with a follow focus adjusting wheel of the camera or video camera. When the adjusting gear rotates, follow focus adjustment can be performed to the camera or video camera, so that the fitness between the second housing 200 and the camera or video camera is improved, the follow focus adjustment effect is better, and at the same time the operation difficulty is reduced.

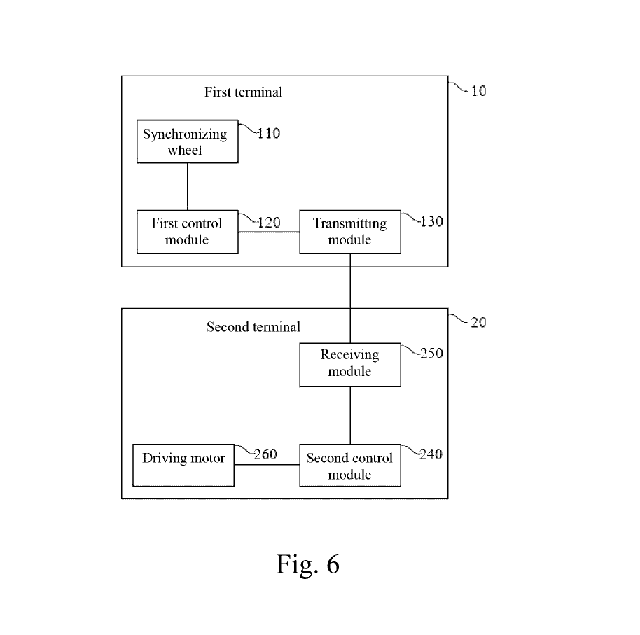

For example, as shown in FIG. 6, the first terminal 10 is a transmitter, and the second terminal 20 is a receiver. The first control module 120 is used for obtaining a control instruction of the user, sending the control instruction to the receiving module 250 on the second terminal 20 through the transmitting module 130. After obtaining the control instruction received by the receiving module 250, the second control module 240 controls the driving motor 260 to work according to the control instruction. Specifically, the synchronizing wheel 110 is used for follow focus adjustment by the user. For instance, the control instruction of the user includes parameters, e.g., rotation rate and angle of the synchronizing wheel 110. The first control module 120 acquires parameters like rotation rate and angle of the synchronizing wheel 110. The related parameters are sent to the receiving module 250 through the transmitting module 130. The second control module 240 controls the driving motor 260 to work according to the rotation rate, angle and other related parameters of the synchronizing wheel 110, such that the adjusting gear 210 rotates correspondingly, thereby realizing follow focus adjustment of the camera or video camera.

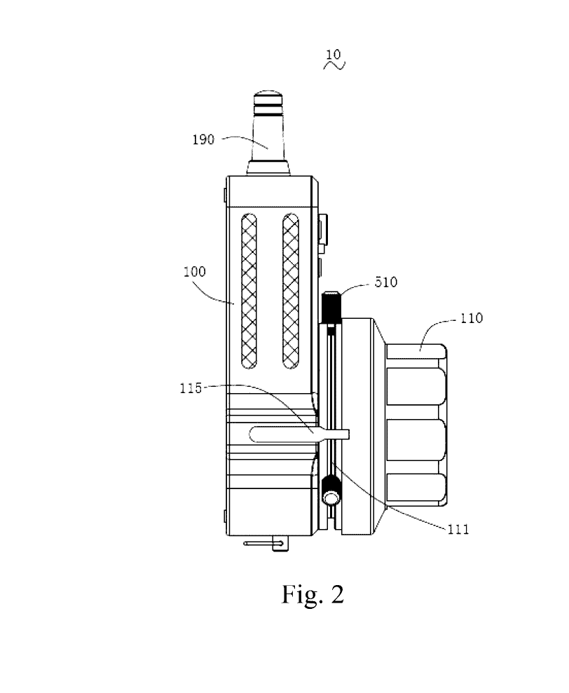

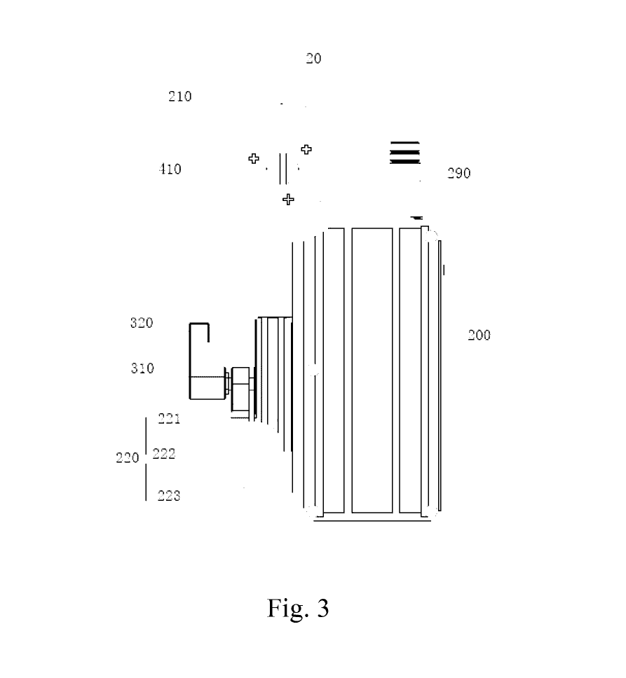

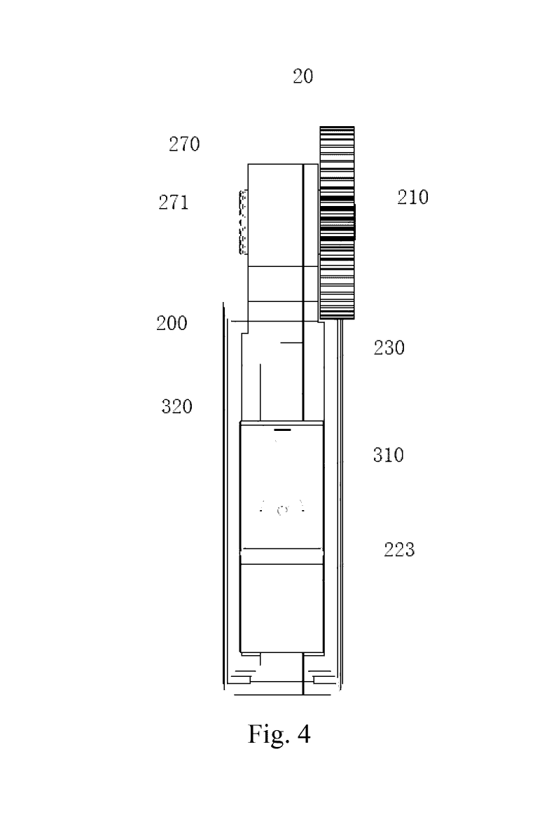

For example, the transmitting module 130 includes a transmitting antenna 190. As shown in FIGS. 1 and 2, the transmitting antenna 190 is disposed on the first housing 100. For example, the receiving module 250 includes a receiving antenna 290. As shown in FIGS. 3 and 4, the receiving antenna 290 is disposed on the second housing 200. The transmitting antenna 190 is wirelessly connected with the receiving antenna 290, including infrared, Bluetooth and radio wave. For example, the transmitting antenna 190 is connected with the receiving antenna 290 through radio wave with a communication frequency of 433 MHz. The radio wave has characteristics of stable propagation and strong anti-interference, such that the communication between the transmitting antenna 190 and the receiving antenna 290 is kept stable, and the accurate control of the second terminal 20 by the first terminal 10 is realized.

For example, the first housing 100 is provided with a key zone having a plurality of keys. The plurality of keys is electrically connected with the first control module 120. As shown in FIG. 1, the keys include four storage keys 180 and a speed control knob 160. Specifically, the first control module 120 has a storage sub-module for storing rotation angle. The four storage keys 180 correspond to four rotation angles. When the storage keys 180 are pressed, the first control module 120 sends the corresponding rotation angle to the second control module 240 according to the storage keys 180, so that the driving motor 260 works according to the corresponding rotation angle of the storage keys 180. At this time, the input instruction of the synchronizing wheel 110 is invalid, and when the user presses the storage keys 180 again, the corresponding rotation angle controlled by the storage keys 180 is invalid, and the user can rotate the synchronizing wheel 110 to control the driving motor 260. In order to control the rotation rate of the driving motor 260 according to the instruction of the storage keys 180, when the driving motor 260 rotates according to the instruction of the storage keys 180, the speed control knob 160 can adjust the rotation rate of the driving motor 260 by this time, thereby controlling the rotation rate of the adjusting gear 210. When the user presses the storage keys 180 again, the corresponding control of the speed control knob is invalid, and the user can rotate the synchronizing wheel 110 to control the driving motor 260. Among the above, the storage and transmission of the rotation angle are realized by using existing technology, which does not belong to the protection scope of the present invention. The present invention only requires protecting the position of the key zone and the connection of the storage keys.

In an embodiment, in order to adjust the degree of tightness of the clamping mechanism 220 such that the second terminal 20 is more easily fixed on the camera or video camera, as shown in FIGS. 3 and 4, the clamping mechanism 220 includes a first connection portion 221, a clamping ring 223 and a second connection portion 222 integrally formed. The second connection portion 222 is slidably disposed in the chute 230. The first connection portion 221, the clamping ring 223 and the second connection portion 222 are orderly connected. The first connection portion 221 is connected with the second connection portion 222 through a bolt 310. The bolt 310 can be used for adjusting the distance between the first connection portion 221 and the second connection portion 222 and for controlling the inner diameter of the clamping ring 223, thereby realizing adjustment of the degree of tightness of the clamping mechanism 220 to fit different cameras or video cameras. Meanwhile, the second terminal 20 can be conveniently fixed on the camera or video camera through the clamping mechanism 220.

For ease of turning of the bolt 310, for example, the bolt 310 has a handheld portion 320 extending along the outer circumferential side of the bolt 310. As such, when the bolt 310 is turned, a hand of the user can abut on the handheld portion 320 to turn the bolt 310 without any other tool, and thus it is convenient for the user to adjust the position of the clamping mechanism 220 and brings convenience for the user.

In order to fix the position of the clamping mechanism 220 and avoid the error caused by displacement between the adjusting gear and the follow focus adjusting wheel of the camera or video camera, for example, the second connection portion 222 has a through hole corresponding to the bolt 310, and the bolt can pass through the through hole to abut on the chute 230. As such, the bolt 310 is tightened to clamp the clamping mechanism 220 on the fixed pole, while the bolt 310 passes through the through hole to abut on the chute 230, such that the second connection portion 222 is fixed within the chute 230, and the position of the clamping mechanism 220 is fixed, thereby avoiding the appearance of the error of the follow focus adjustment.

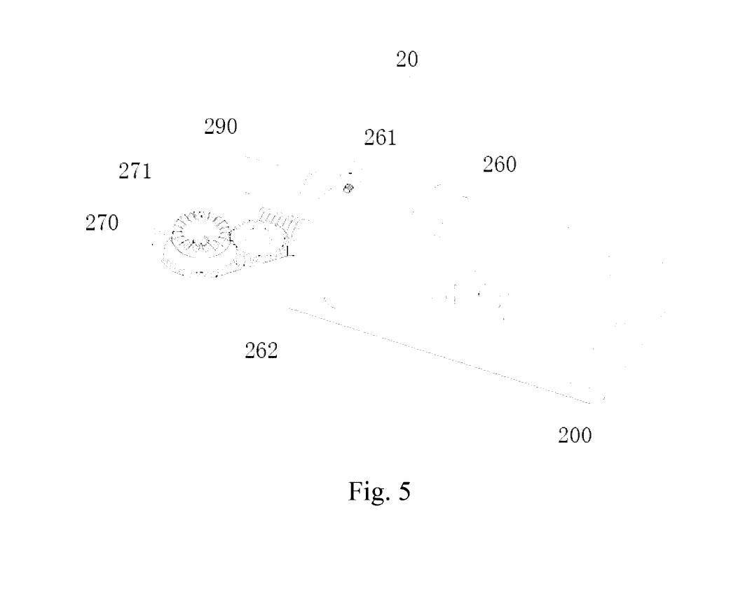

In order to reduce the energy consumption of the driving motor 260, the driving energy of the driving motor 260 is increased. As shown in FIG. 5, the second housing 200 is provided with a transmission gear 262 and a driven gear 270. The driving motor 260 is connected with the transmission gear 262. The transmission gear 262 is engaged with the driven gear 270. The adjusting gear 210 is engaged with the driven gear 270. Specifically, the driving motor 260 is connected with a worm 261 engaged with the transmission gear 262. For better engagement with the worm 261, the transmission gear 262 is configured as a bevel cylindrical gear. The transmission gear 262 can efficiently improve the driving energy of the driving motor 260, such that the rotation rate of the adjusting gear 210 is faster, and the energy consumption of the driving motor 260 is reduced. For example, the driving motor 260 is a servo motor, and the transmission gear 262 improves the driving capability. Therefore, in order to save the production cost, a servo motor with low power can be used as the driving motor 260.

In order to further improve the fitness of the second terminal 20 to the camera or video camera, as shown in FIG. 4, the driven gear 270 has a first tooth surface 271 and a second tooth surface disposed opposite to each other. The adjusting gear 210 is engaged with the first tooth surface 271 or the second tooth surface. For example, connection teeth are formed on one side of the adjusting gear 210. The adjusting gear 210 is engaged with the first tooth surface 270 or the second tooth surface through the connection teeth. As such, the adjusting gear 210 is installed on two sides of the first terminal 10 to fit different cameras or video cameras. As shown in FIG. 4, the adjusting gear 210 is engaged with the second tooth surface. For instance, in order to limit the adjusting gear 210 and avoid slip of the adjusting gear 210, an installing hole is formed in the middle of the adjusting gear 210. A screw 410 is disposed in the installing hole. The adjusting gear 210 is connected with the first housing 100 through the screw 410, and the adjusting gear 210 rotates about the screw 410.

In order to avoid excessive rotation of the synchronizing wheel 110, as shown in FIGS. 1 and 2, the first housing 100 has a fixture block 115 disposed on the outer circumferential side of the synchronizing wheel 110. A blocking mechanism for abutting on the fixture block 115 is disposed on the circumference of the synchronizing wheel 110. As such, in the rotation of the synchronizing wheel 110, when the blocking mechanism abuts on the fixture block 115, the synchronizing wheel 110 stops rotating to avoid excessive rotation, and the rotation angle of the synchronizing wheel 110 can be efficiently limited, which fits different follow focus adjustment requirements of the user.

In order to improve the control precision on rotation of the synchronizing wheel 110, for example, the blocking mechanism is a blocking screw 510, see FIG. 2. A screw jointing slot 111 is formed on the circumference of the synchronizing wheel 110. The blocking screw 510 is screw-jointed on the screw jointing slot 111 of the synchronizing wheel 110. The blocking screw 510 can be screw-jointed in different positions on the screw jointing slot 111, and the blocking screw 510 in different positions limits different rotation angles of the synchronizing wheel 110; in order to further improve the control precision, for example, the screw jointing slot 111 on the circumference of the synchronizing wheel 110 is screw-jointed with two blocking screws 510, and the two blocking screws 510 limit the rotation angle of the synchronizing wheel 110 between to meet the follow focus adjustment requirements and avoid excessive rotation of the synchronizing wheel 110 to cause error of the follow focus adjustment.

The technical features of the above-mentioned embodiments can be combined randomly. To simplify the description, not all possible combinations of the technical features of the above-mentioned embodiments are described. However, the combinations of these technical features should be considered as falling within the scope of the specification as long as there is no conflict.

The above-mentioned embodiments only show several implementations of the present invention, and the description is specific and particular, but it cannot be understood as limiting of the patent scope of the present invention. Note that for those skilled in the art, various variations and improvements can be made without departing from the idea of the present invention, and all fall within the protection scope of the present invention. Therefore, the scope of patent protection of the present invention is subject to the appended claims.

What is claimed is:

1. A follow focus device, characterized in that, it comprises a first terminal and a second terminal;
the first terminal comprises a first housing, a first control module, a transmitting module and a synchronizing wheel; the first control module is disposed within the first housing; the transmitting module is fixedly disposed on the first housing and electrically connected with the first control module; the synchronizing wheel is rotatably disposed on the first housing and electrically connected with the first control module;
the second terminal comprises a second housing, a second control module, a receiving module, a driving motor, an adjusting gear and a clamping mechanism; the second control module is disposed within the second housing; the receiving module is fixedly disposed on the second housing and electrically connected with the second control module; the receiving module is connected with the transmitting module; the second control module is electrically connected with the driving motor; the driving motor is fixedly disposed on the second housing and is connected with the adjusting gear in a driving manner; the second housing has a chute; and the clamping mechanism is slidably disposed in the chute;
the first housing has a fixture block disposed on the outer circumferential side of the synchronizing wheel; and a blocking mechanism for abutting on the fixture block is disposed on the circumference of the synchronizing wheel.

2. The follow focus device according to claim 1, characterized in that, the clamping mechanism comprises a first connection portion, a clamping ring and a second connection portion integrally formed; the second connection portion is slidably disposed in the chute; the first connection portion, the clamping ring and the second connection portion are orderly connected; and the first connection portion is connected with the second connection portion through a bolt.

3. The follow focus device according to claim 2, characterized in that, the bolt has a handheld portion.

4. The follow focus device according to claim 1, characterized in that, the second housing is provided with a transmission gear and a driven gear; the driving motor is connected with the transmission gear; the transmission gear is engaged with the driven gear; and the adjusting gear is engaged with the driven gear.

5. The follow focus device according to claim 4, characterized in that, the driving motor is connected with a worm; and the worm is engaged with the transmission gear.

6. The follow focus device according to claim 4, characterized in that, the driven gear has a first tooth surface and a second tooth surface disposed opposite to each other; and the adjusting gear is engaged with the first tooth surface or the second tooth surface.

7. The follow focus device according to claim 1, characterized in that, the blocking mechanism is a blocking bolt; a screw jointing slot is formed on the circumference of the synchronizing wheel; and the blocking screw is screw-jointed on the screw jointing slot of the synchronizing wheel.

8. The follow focus device according to claim 7, characterized in that, two blocking mechanisms are disposed on the circumference of the synchronizing wheel.

9. The follow focus device according to claim 1, characterized in that, the transmitting module comprises a transmitting antenna disposed on the first housing; and the receiving module comprises a receiving antenna disposed on the second housing.

10. The follow focus device according to claim 2, characterized in that, the transmitting module comprises a transmitting antenna disposed on the first housing; and the receiving module comprises a receiving antenna disposed on the second housing.

11. The follow focus device according to claim 3, characterized in that, the transmitting module comprises a transmitting antenna disposed on the first housing; and the receiving module comprises a receiving antenna disposed on the second housing.

12. The follow focus device according to claim 4, characterized in that, the transmitting module comprises a transmitting antenna disposed on the first housing; and the receiving module comprises a receiving antenna disposed on the second housing.

13. The follow focus device according to claim 5, characterized in that, the transmitting module comprises a transmitting antenna disposed on the first housing; and the receiving module comprises a receiving antenna disposed on the second housing.

14. The follow focus device according to claim 6, characterized in that, the transmitting module comprises a transmitting antenna disposed on the first housing; and the receiving module comprises a receiving antenna disposed on the second housing.

15. The follow focus device according to claim 7, characterized in that, the transmitting module comprises a transmitting antenna disposed on the first housing; and the receiving module comprises a receiving antenna disposed on the second housing.

16. The follow focus device according to claim 8, characterized in that, the transmitting module comprises a transmitting antenna disposed on the first housing; and the receiving module comprises a receiving antenna disposed on the second housing.
